(19) United States
(12) Patent Application Publication
(10) Pub. No.: US 2004/0162695 A1
(43) Pub. Date: Aug. 19, 2004

(54) Unqualified person driving prevention apparatus for vehicle

(75) Inventor: Shinobu Tanaka, Kyoto (JP)

Correspondence Address: SUGHRUE MION, PLLC, 2100 PENNSYLVANIA AVENUE, N.W., SUITE 800, WASHINGTON, DC, 20037, US

(73) Assignee: NIPPON YUSOKI CO., LTD.

(21) Appl. No.: 10/695,817

(22) Filed: Oct. 30, 2003

(30) Foreign Application Priority Data
Dec. 11, 2002 (JP) P 2002-359834
Dec. 13, 2002 (JP) P 2002-361809

(51) Int. Cl. G01D 1/00

(52) U.S. Cl. 702/127

(57) ABSTRACT

An unqualified person driving prevention apparatus has a qualified person marker held by a person having driving qualification. This marker is continuously detected and when the marker is not detected, a predetermined measure to ensure safety is taken. The measure may be a warning to a driver through the sense of sight or the sense of hearing, or a driving stop of a vehicle. When the qualified person marker is detected during execution of the measure to ensure safety, the execution of the measure can be released.

### BACKGROUND OF THE INVENTION

1. Field of the Invention

The present invention relates to an apparatus for preventing an unqualified person from driving a vehicle so that there is no possibility that a person without driving qualification drives the vehicle and causes an accident.

2. Description of the Related Art

According to an associated act, vehicles such as forklifts can be driven only by a forklift driving skill course completion person (qualified person). However, there is a case in which a person without qualification drives the vehicle and causes an accident, and measures are required.

An apparatus has conventionally been proposed (for example, JP-A-2000-351598) in which a fingerprint identification device is mounted in a forklift and only in the case of checking fingerprints of a driver and judging that the driver is a legal qualified person, a power source of the forklift is turned on to start the vehicle.

However, even in the case where the vehicle is started judging that a driver is a qualified person, there is a situation in which an unqualified person rides in the vehicle to start driving when the qualified driver leaves the vehicle. Therefore, in the conventional art described above, such a situation cannot be prevented and sufficient measures are not necessarily taken.

Further, accuracy of a check by fingerprints is low, and conducting the check operation is troublesome. Even in a case in which an IC card is employed for checking, it is inconvenient that a driver need to carry the IC card, and conducting the check operation is troublesome. Further, there is a possibility that the IC card is passed to an unqualified person. Therefore, driving by the unqualified person cannot be prevented reliably in such a method.

### SUMMARY OF THE INVENTION

In view of such disadvantages, an object of the present invention is to provide an apparatus capable of simply and reliably preventing an unqualified person from driving a vehicle.

According to a first aspect of the invention, there is provided an unqualified person driving prevention apparatus for a vehicle, including: a qualified person marker held by a driver having driving qualification; a marker detector provided in the vehicle to detect the qualified person marker; and a control unit for continuously monitoring an output from the marker detector and taking a predetermined measure to ensure safety when a state occurs in which the qualified person marker is not detected. According to this configuration, it is monitored whether or not a driver is a person having qualification not only at the time of starting a vehicle but also thereafter continuously. Since the marker becomes undetectable when the driver having the qualification leaves the vehicle, the predetermined measure to ensure safety is taken by the control unit. The continuous monitoring means an operation of monitoring continuously or at regular intervals of short time. This monitoring is continuously performed, for example, while a key switch for starting the vehicle is in an on state. The qualified person marker is provided in clothes, shoes, a helmet, etc., of the driver so that the marker can be detected by the marker detector of the vehicle body side.

According to a second aspect of the invention, the measure is a warning for appealing to the sense of sight or the sense of hearing of the driver. The warning for appealing to the sense of sight of the driver is, for example, blinking of a lamp, and the warning for appealing to the sense of hearing of the driver is, for example, sound of a buzzer. According to this configuration, when a driver without the driving qualification rides in the vehicle body, a warning is given so that the driver does not drive by notifying by the lamp or the buzzer that driving is not permitted.

According to a third aspect of the invention, the measure is a driving stop of the vehicle. According to this configuration, when a driver without the driving qualification rides in the vehicle body, driving of the vehicle body can be prohibited forcedly.

According to a fourth aspect of the invention, the measure has a warning for appealing to the sense of sight or the sense of hearing of a driver and a driving stop of the vehicle performed after the warning. According to this configuration, when a driver without the driving qualification rides in the vehicle body, since driving of the vehicle body is prohibited forcedly after a warning is given so that the driver does not drive by notifying by the lamp or the buzzer that driving is not permitted, there is an advantage that there is no possibility of incorrectly deciding that the stop is due to failure of the vehicle body.

According to a fifth aspect of the invention, the measure is released when the detector again detects the marker. That is, the measure is released by detecting the marker when a driver again rides in a vehicle in the case where the driver gets out of the vehicle and the measure is started. When the measure is blinking of a lamp, the blinking of the lamp is stopped. When the measure is sound of a buzzer, the sound is stopped. When the measure is a driving stop of the vehicle, this stop is released and the vehicle is driven or returns to a state capable of driving.

According to a sixth aspect of the invention, the control unit takes the measure when a state occurs in which the qualified person marker is not detected for a predetermined time period. That is, in this sixth aspect of the invention, the measure is not started as soon as a state occurs in which the marker becomes undetectable, and the measure is taken when the predetermined time period has elapsed since the state occurs. According to this configuration, in the case where the detector cannot detect the marker due to vibration or swing of a vehicle body, there is no possibility of incorrectly deciding that a driver having qualification is absent.

According to a seventh aspect of the invention, a driver detector for detecting the presence or absence of a ride of a driver is provided in the vehicle, and the control unit takes the measure when the marker is not detected by the marker detector and the driver is detected by the driver detector. That is, in this configuration, the measure is taken only when a driver without driving qualification rides in a vehicle body. Therefore, according to this configuration, for example, when the measure is sound of a buzzer, the buzzer is sounded only when it is necessary to warn the driver, so that there are advantages that electric power necessary for sound of the buzzer can be reduced and unnecessary noise is not given in the vicinity of the vehicle. The driver detector can be constructed of means for detecting the presence or absence of the driver by variations in a load of a cab or means for detecting the presence or absence of the driver by providing a photoelectric sensor in a cab, and it may be constructed so that when a driver operates an operation device such as a lever or a switch provided in the vehicle, this operation is detected and it is decided that the driver is present.

According to an eighth aspect of the invention, there is provided an unqualified person driving prevention apparatus for a vehicle, including: a qualified person marker provided in a shoe worn by a driver having driving qualification; a marker detector provided in a floor of a cab of the vehicle to detect the qualified person marker; and a control unit for monitoring an output from the marker detector and taking a predetermined measure to ensure safety when a state occurs in which the qualified person marker is not detected. According to this configuration, even when a driver does not perform a check operation of the fingerprints or the card, it can be detected simply and reliably whether or not the driver has the driving qualification. Also, since a shoe of the driver is always in opposite contact with the floor of the vehicle body cab, detection of the marker by the marker detector is reliably performed and there is a very low possibility of error detection. Further, when it is decided that the driver is an unqualified person, by taking a proper measure to ensure safety, a possibility of an accident decreases and therefore, safety management can be improved.

### BRIEF DESCRIPTION OF THE DRAWINGS

FIG. 1 is a perspective view showing a forklift according to an embodiment of the present invention, when viewed from a rear side;

FIG. 2 is a block diagram showing a configuration of an unqualified person driving prevention apparatus according to an embodiment of the present invention;

FIG. 3 is a plan view schematically showing a floor surface of a cab of the forklift; and

FIG. 4 is a flowchart showing a control procedure of the unqualified person driving prevention apparatus.

### DETAILED DESCRIPTION OF THE PREFERRED EMBODIMENTS

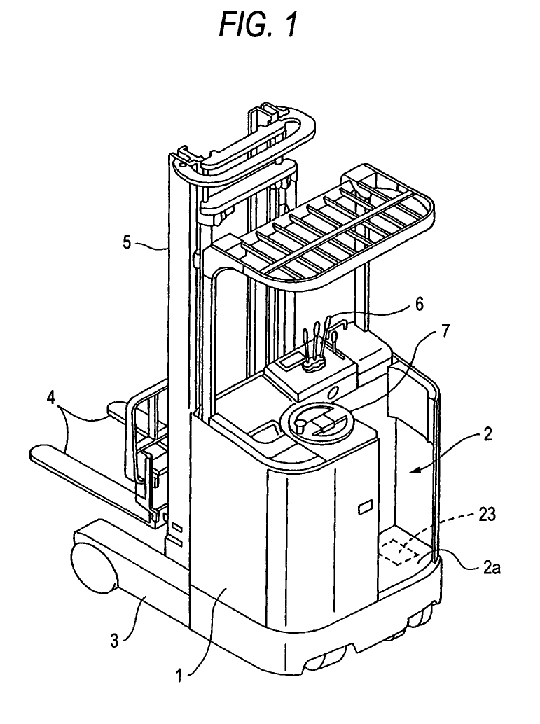

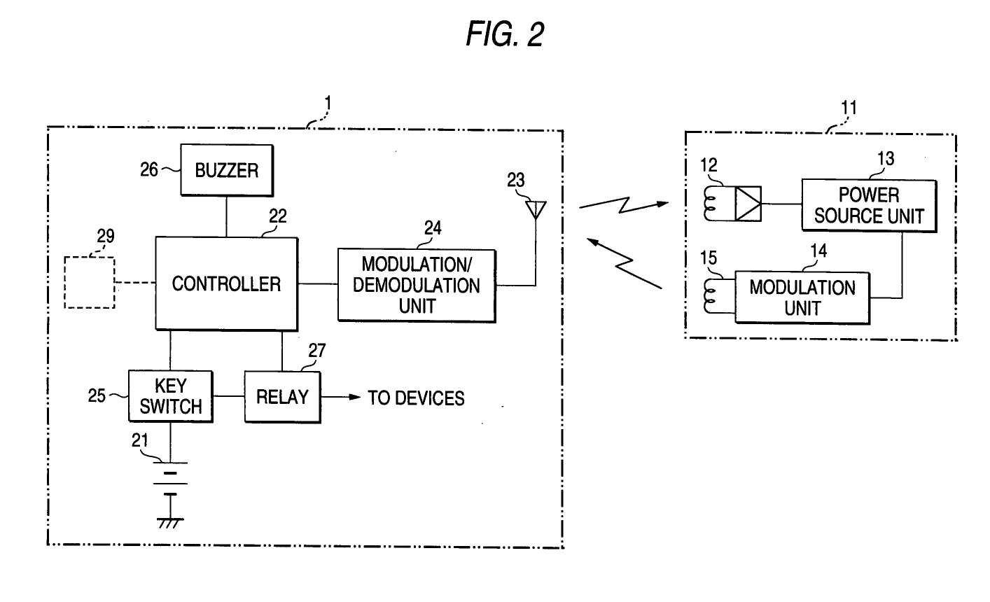

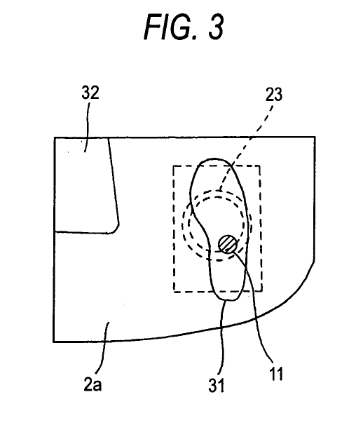

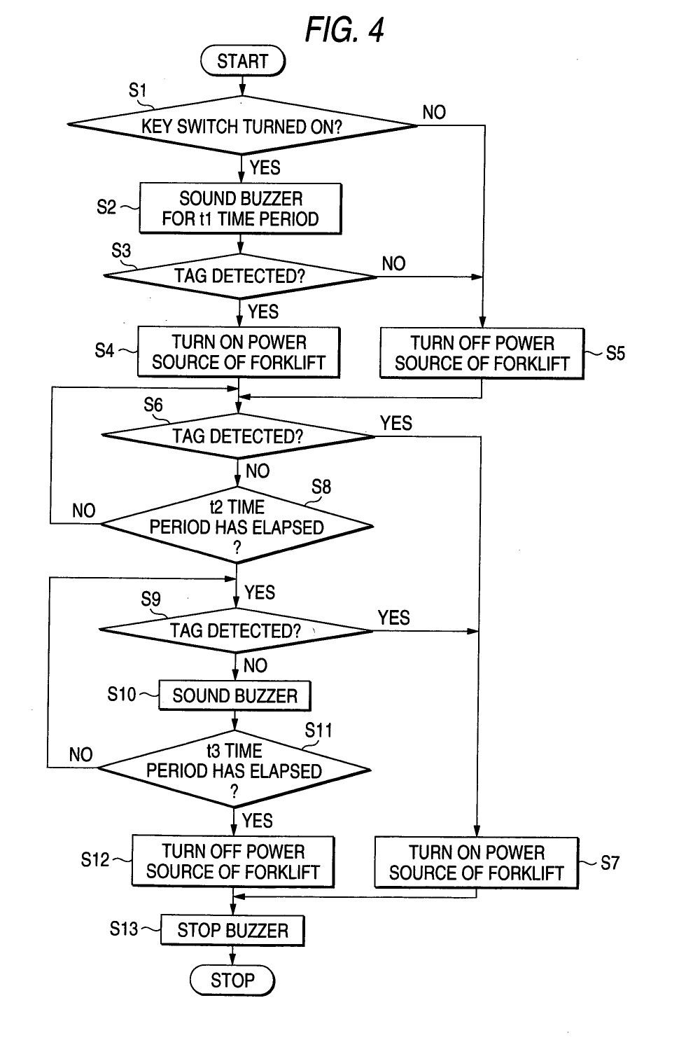

An embodiment of the invention will be described below with reference to the accompanying drawings. Incidentally, in the following description, a forklift is exemplified as a cargo handling vehicle. FIG. 1 is a perspective view showing a forklift according to an embodiment of the present invention, when viewed from a rear side. FIG. 2 is a block diagram showing a configuration of an unqualified person driving prevention apparatus according to an embodiment of the present invention. FIG. 3 is a plan view schematically showing a floor surface of a cab of the forklift. FIG. 4 is a flowchart showing a control procedure of the unqualified person driving prevention apparatus.

As shown in FIG. 1, a reach type forklift according to the embodiment includes a vehicle body 1 in which a battery that is a power source for driving, a travel device, a steering device, an oil hydraulic source device, and a controller, etc., are installed, though not shown. The vehicle body 1 has straddle arms 3 extending forward from the front side thereof, and a cab 2 provided in the rear side thereof.

A mast device 5 for guiding up and down operation (lift operation) of a fork 4 is vertically provided on each of the straddle arms 3. The mast device 5 advances and retracts (conducts reach operation) together with the fork 4. The cab 2 of the vehicle body 1 is provided with levers 6 for various operations, a steering wheel 7, and various instruments (not shown).

Further, an unqualified person driving prevention apparatus is installed in the forklift. The prevention apparatus continuously detects a qualified person marker given to only a driver having qualification for driving the forklift, and conducts certain procedures to ensure safety when the qualified person marker cannot be detected. This prevention apparatus is, for example, an apparatus using an electromagnetic induction method, in which an authentication tag 11 serving as an IC tag that is a qualified person marker is previously supplied to a driver having qualification for driving the forklift, namely a qualified person of driving.

The authentication tag 11 supplied to the qualified person has a small disk shape in which a receiving antenna 12, a power source unit 13, a modulation unit 14, and a sending antenna 15 are disposed, as shown in FIG. 2, and is provided on an insole of work shoes worn by the qualified person. The authentication tag 11 is constructed so that the power source unit 13 generates driving electric power using radio waves (electromagnetic waves) received by the receiving antenna 12, and radio waves modulated by the modulation unit 14 are sent from the sending antenna 15.

On the other hand, a battery 21 that is a driving source of the vehicle, a controller 22 serving as a control unit, a sending/receiving antenna 23 serving as a detector for detecting the authentication tag 11, and a modulation/demodulation unit 24 are disposed in the vehicle body 1 of the forklift. In this embodiment, the sending/receiving antenna 23 is provided inside a floor 2a of the cab 2 on which the driver stands. The sending/receiving antenna 23 is positioned so as to be opposed to the authentication tag 11 in the work shoes of the qualified person, and radio waves of a long wave band (about 125 KHz) are sent and received between the receiving antenna 12 and the sending antenna 15 of the authentication tag 11 and the sending/receiving antenna 23. Therefore, the sending/receiving antenna 23 continuously detects the authentication tag 11. Incidentally, a numeral 27 in FIG. 2 designates a relay, and a numeral 32 in FIG. 3 designates a brake pedal.

The radio waves sent and received by the sending/receiving antenna 23 is modulated and demodulated by the modulation/demodulation unit 24. Operations of this modulation/demodulation unit 24 is controlled by the controller 22. This controller 22 has a function of judging that driving is conducted by an unqualified person when the authentication tag 11, which indicates that a person driving the forklift is a qualified person, is not detected.

Further, in the vehicle body 1, a key switch 25 and a relay circuit 27 are interposed between the battery 21 and various devices, and on-off control of this relay circuit 27 is also conducted by the controller 22. In the vicinity of the cab 2 of the vehicle body 1, a buzzer 26 for giving a warning to a driver of the forklift by appealing to the sense of hearing of the driver is provided as a warning unit. This buzzer 26 sounds by instructions of the controller 22.

That is, the buzzer 26 sounds according to instructions from the controller 22 that judges that driving is conducted by an unqualified person. Incidentally, the warning unit is not limited to the buzzer. The warning unit may be a light emitting lamp etc., for giving a warning to the driver through the sense of sight.

Now, an operation procedure of a driver identification system according to the embodiment will be described with reference to FIG. 4. First of all, a driver riding on a forklift turns on the key switch 25 provided in the cab 2 (step S1). Then, a power source of the controller 22 is turned on, and in order to provide notification of normal operation of the forklift and the unqualified person driving prevention apparatus, the buzzer 26 sounds for t1 time period, for example, for about one second (step S2).

Subsequently, the authentication tag 11 held by the driver is detected through the sending/receiving antenna 23 and the controller 22 judges whether or not the driver is a qualified person (step S3). If the authentication tag 11 is detected, the controller 22 judged that the driver is the qualified person, and the relay circuit 27 is turned on and a power source of the forklift is turned on (step S4).

If the authentication tag 11 is not detected, the controller 22 judges that driving is conducted by an unqualified person, and the relay 27 is turned off, so that the power source is turned off (step S5) and driving of the vehicle is stopped. During the driving of the forklift started in accordance with turning on of the power source, the authentication tag 11 is continuously detected (step S6) and as long as the authentication tag 11 is detected, on state of the power source continues (step S7), so that the forklift can be driven.

On the other hand, when an unqualified person rides in the forklift to start driving after a qualified person leaves from the forklift with the power source turned on, the authentication tag 11 is not detected (step S6). Then, when a state in which the authentication tag 11 is not detected continues for t2 time period, for example, for about five minutes (step S8), after checking that the authentication tag 11 is not detected (step S9), the buzzer 26 sounds by instructions from the controller 22 which decides that driving is conducted by the unqualified person (step S10).

Therefore, the unqualified person who recognizes that the buzzer is a warning to him is forced to stop the driving of the forklift spontaneously. Further, in the case where the unqualified person does not stop driving spontaneously even though the buzzer 26 is sounding, after waiting for t3 time period (about one minute) to elapse (step S11), the relay circuit 27 is turned off and the power source of the forklift is turned off (step S12).

As a result, it becomes impossible for the unqualified person to continue driving the forklift, and driving of the forklift by the unqualified person is forcedly stopped. Then, after the power source of the forklift is turned off, sound of the buzzer 26 is stopped (step S13). In the embodiment, the buzzer 26 is used as the warning unit. The warning unit may be a speaker and in this case, it is preferable to send out a message that “please move to a safe place at once and stop driving.”

By the way, in the case where the authentication tag 11 is detected during the sound of the buzzer 26 in step S9, for example, the case that a qualified person who has got out of the vehicle body rides again, the power source of the forklift continues to be turned on (step S7).

In the embodiment described above, it is judged whether or not driving is conducted by a qualified person by continuously detecting a qualified person marker. Therefore, when the qualified person marker cannot be detected during the driving of a forklift, it is decided that driving is conducted by an unqualified person and a warning is given or driving of the vehicle is stopped, so that it becomes impossible to continue driving, with the result that the driving by the unqualified person is prevented effectively. The qualified person marker is provided in a shoe and also a detector is provided in a floor of a cab, so that it becomes easy to continuously detect the qualified person marker. Incidentally, the invention is not limited to the case of continuously detecting such a qualified person marker and can be applied to, for example, the case of detecting the marker only at the time of starting the driving.

Incidentally, in the embodiment described above, an apparatus for preventing the driving by the unqualified person is constructed using an electromagnetic induction method, but may be constructed using an electromagnetic coupling method or a microwave method without being limited to only the electromagnetic induction method. As long as the qualified person marker is detectable by the detector provided in a cab floor surface, the qualified person marker may be provided inside or outside of a sole of the shoe. Further, this qualified person marker is not limited to an IC tag and, for example, it can also be constructed so that a reflecting mirror is provided in the outer bottom of the shoe and this qualified person marker is reflected and detected by an optical sensor for emitting light provided in the cab floor surface. Further, other means can also be used. However, in the point of view that the qualified person marker can be held in the sole of the shoe compactly and it can reliably be detected that a driver is a qualified person registered previously, it is most suitable to use the IC tag described in the embodiment. Furthermore, the embodiment described above is constructed so that a buzzer sounds automatically in a state in which the authentication tag 11 is not detected for a predetermined period of time. But it can also be constructed so that a driver detector 29 (see FIG. 2) including a sensor for detecting the presence or absence of a ride of a driver is provided in this forklift and the buzzer is sounded in the case where the driver detector detects the ride of the driver in a state in which the authentication tag 11 is not detected for a predetermined time period. Also, the invention is not limited to the forklift described in the embodiment, and can be applied to various vehicles.

By the way, in the case where the authentication tag 11 is detected during the sound of the buzzer 26 in step S9, the power source of the forklift continues to be turned on (step S7). For example, when the authentication tag 11 becomes undetectable by the fact such as a qualified person changes his standing point, the qualified person is notified by sound of the buzzer 26. When the qualified person corrects his standing point so that the authentication tag 11 is detected during the sound of the buzzer 26 in step S9, the power source of the forklift continues to be turned on (step S7).

According to the first aspect of the invention, it is monitored whether or not a driver is a person having qualification not only at the time of starting a vehicle but also thereafter continuously, so that even when the driver alternates on the way, driving by an unqualified person can be prevented and therefore, there is an effect capable of achieving reliable safety management.

According to the second aspect of the invention, when a driver without driving qualification rides in a vehicle body, there is an effect capable of giving a warning so that the driver does not drive by notifying by a lamp or a buzzer that driving is not permitted.

According to the third aspect of the invention, when a driver without driving qualification rides in a vehicle body, there is an effect capable of reliably preventing driving by an unqualified person since driving of the vehicle body can be prohibited forcedly.

According to the fourth aspect of the invention, when a driver without driving qualification rides in a vehicle body, since driving of the vehicle body is prohibited forcedly after a warning is given so that the driver does not drive by notifying through a lamp or a buzzer that driving is not permitted, there is an effect that there is no possibility of incorrectly deciding that a driving stop of the vehicle body is due to failure.

According to the fifth aspect of the invention, even when a driver having driving qualification gets out of a vehicle and driving of a vehicle body is stopped, the driving of the vehicle body can be restarted at once when the driver again rides on the vehicle, so that it is convenient.

According to the sixth aspect of the invention, in the case that marker detector cannot detect a qualified person marker due to vibration or swing of a vehicle body, a disadvantage that it is incorrectly decided that a driver having qualification is absent and driving of the vehicle body is stopped can be prevented. Also, at the time when the driver having qualification gets out of a vehicle and returns to the vehicle at once, driving of the vehicle body is not stopped every time, so that it is convenient.

According to the seventh aspect of the invention, for example, measures such as sound of a buzzer are taken only when it is necessary to warn a driver, so that there are effects that electric power necessary for sound of the buzzer can be reduced and unnecessary noise is not given in the vicinity of a vehicle.

According to the eighth aspect of the invention, it can be detected simply and reliably whether or not a driver has driving qualification. Also, when it is decided that the driver is an unqualified person, by taking proper measures to ensure safety, a possibility of an accident decreases and therefore, safety management can be improved.

What is claimed is:

1. An unqualified person driving prevention apparatus for a vehicle, comprising:
a qualified person marker held by a driver having driving qualification;
a marker detector provided in the vehicle to detect the qualified person marker; and
a control unit for continuously monitoring an output from the marker detector and taking a predetermined measure to ensure safety when a state occurs in which the qualified person marker is not detected.

2. The unqualified person driving prevention apparatus for a vehicle as claimed in claim 1, wherein the measure is a warning for appealing to the sense of sight or the sense of hearing of the driver.

3. The unqualified person driving prevention apparatus for a vehicle as claimed in claim 1, wherein the measure is a driving stop of the vehicle.

4. The unqualified person driving prevention apparatus for a vehicle as claimed in claim 1, wherein the measure comprises a warning for appealing to the sense of sight or the sense of hearing of the driver and a driving stop of the vehicle performed after the warning.

5. The unqualified person driving prevention apparatus for a vehicle as claimed in claim 1, wherein the measure is released when the marker detector again detects the qualified person marker.

6. The unqualified person driving prevention apparatus for a vehicle as claimed in claim 1, wherein the control unit takes the measure when a state occurs in which the qualified person marker is not detected for a predetermined time period.

7. The unqualified person driving prevention apparatus for a vehicle as claimed in claim 1, further comprising a driver detector for detecting the presence or absence of a driver riding on the vehicle, wherein the control unit takes the measure when the qualified person marker is not detected by the marker detector and the driver is detected by the driver detector.

8. An unqualified person driving prevention apparatus for a vehicle, comprising:
a qualified person marker provided in a shoe worn by a driver having driving qualification;
a marker detector provided in a floor of a cab of the vehicle to detect the qualified person marker; and
a control unit for monitoring an output from the marker detector and taking a predetermined measure to ensure safety when a state occurs in which the qualified person marker is not detected.

9. The unqualified person driving prevention apparatus for a vehicle as claimed in claim 8, wherein the measure is a warning for appealing to the sense of sight or the sense of hearing of the driver.

10. The unqualified person driving prevention apparatus for a vehicle as claimed in claim 8, wherein the measure is a driving stop of the vehicle.

11. The unqualified person driving prevention apparatus for a vehicle as claimed in claim 8, wherein the measure comprises a warning for appealing to the sense of sight or the sense of hearing of the driver and a driving stop of the vehicle performed after the warning.
